(19) United States
(12) Patent Application Publication
(10) Pub. No.: US 2002/0118406 A1
(43) Pub. Date: Aug. 29, 2002

(54) Integrated scanning device for reflection scanning and transparency scanning

(76) Inventor: Chih-Wen Huang, Hsinchu (TW)

Correspondence Address: J.C. Patents, Inc., 1340 Reynolds Ave., Suite 114, Irvine, CA, 92614, US

(21) Appl. No.: 09/793,944

(22) Filed: Feb. 27, 2001

(51) Int. Cl. H04N 1/46

(52) U.S. Cl. 358/506

(57) ABSTRACT

A scanning device capable of operating in a reflection mode or a transparency mode. The scanning device includes a transparency processing section, a reflection processing section and an optical system. The transparency processing section includes a document feeding port, a plurality of rollers, a first light source and a driving motor. The document feed port has a narrow slit in the upper surface of the scanning device. The rollers are aligned from the document feeding port down towards the base of the scanning device. The first light source is positioned between the side edge and the document feeding port. The driving motor is responsible for driving the rollers. The reflection processing section is located on the upper surface of the scanning device. The reflection processing section includes a second light source. The optical system includes a first reflecting mirror, a second reflecting mirror set, a lens and an optical sensor. The first reflecting mirror is located at the cross-point between light coming from the first light source and light coming from the second light source. The first reflecting mirror permits light from the first light source to pass through by rotating the first reflecting mirror away from a blocking position or using a semi-transparent material. The first reflecting mirror also redirects light coming from the second light source to the lens via the second reflecting mirror set. The lens focuses light from the first light source or the second light source and projects the light onto the optical sensor for the production of an image.

### BACKGROUND OF THE INVENTION

1. Field of Invention

The present invention relates to a scanning system capable of operating in a reflection mode or a transparency mode. More particularly, the present invention relates to an integrated scanning device for performing both reflection scanning and transparency scanning.

2. Description of Related Art

In general, scanning systems can be divided into reflection scanning systems and transparency scanning systems. In a reflection scanning system, a document (an opaque document) for scanning is placed over a transparent glass panel. Light from a light source penetrates through the transparent glass panel to arrive at the document. The light reflected from the document travels through an optical system before arriving at an optical sensor such as a charge coupled device (CCD) to form an image. In a transparency scanning system, a document (a film negative or a projection transparency) is similarly placed on a transparent glass panel. However, light from a light source penetrates the transparent document as well as the transparent glass panel to reach an optical system. Finally, the light travels from the optical system to an optical sensor where an image is formed.

FIG. 1 is a cross-sectional side view of a conventional scanning system. To operate the scanning system in the reflection mode, a scan document 40 is placed over a transparent glass panel 20. A light source 38 on a sense-carrier 30 emits light. Light from the light source 3 8 travels through the transparent glass panel 20 and arrives at the document 40. The light is reflected by the document 40 and travels back through a narrow slit 34 into the sense-carrier 30. Inside the sense-carrier, an optical system 36 directs the reflected light to an optical sensor 32 (CCD). The optical sensor 32 receives the light and converts the light into an image pattern, thereby completing a single scanning step. Thereafter, the sense-carrier 30 moves a little further along the transparent glass panel 20 and prepares for the next scanning operation. This process is repeated until the entire document 40 is converted into image data by the reflection scanning system. Throughout the operation of the reflection scanning system, a light source carrier 10 in the upper portion of the scanner remains stationary.

To operate the scanning system in the transparency mode, a transparent document 40 is similarly placed over the transparent glass panel 20. A light source 12 inside the light source carrier 10 emits light through a slit 14. The light travels through the transparent document 40 and the transparent glass panel 20 and enters the sense-carrier 30 through the slit 34. The light passes through the optical system 36 before arriving at the optical sensor 32. The optical sensor converts the light into an optical image, thereby completing a single scanning step. Thereafter, the light source carrier 10 and the sense-carrier 30 move a little further along the transparent glass panel 20 and prepare for the next scanning operation. This process is repeated until the entire document 40 is converted into image data by the transparency scanning system. Throughout the operation of the transparency scanning system, the light source 38 within the sense-carrier 30 emits no light.

In a conventional scanner, an auxiliary light source 12 mounted on a light source carrier 12 is needed to perform a transparency scanning. The light source carrier 10 and the sense-carrier 30 must be perfectly synchronized or a scanning mismatch may occur. In addition, the installation of a separate carrier 10 increases production cost.

### SUMMARY OF THE INVENTION

Accordingly, one object of the present invention is to provide a scanning device capable of reflection scanning or transparency scanning. The scanning device requires no special synchronization between a separate light source carrier and a sense carrier and has a lower production cost.

To achieve these and other advantages and in accordance with the purpose of the invention, as embodied and broadly described herein, the invention provides a scanning device capable of operating in a reflection mode or a transparency mode. The scanning device has a side edge and an upper surface. The scanning system includes a transparency processing section, a reflection processing section and an optical system. The transparency processing section is located inside the scanner device, close to the side edge. The transparency processing section includes a document feeding port, a plurality of rollers, a first light source and a driving motor. The document feed port has a narrow slit on the upper surface of the scanning device. The rollers are aligned from the document feeding port down towards the base of the scanning device. The first light source is positioned between the side edge and the document feeding port. The driving motor is responsible for driving the rollers. The reflection processing section is located inside the scanning device close to the upper surface. The reflection processing section includes a second light source. The optical system includes a first reflecting mirror, a second reflecting mirror set, a lens and an optical sensor. The first reflecting mirror is located at the cross-point between light coming from the first light source and light coming from the second light source. The first reflecting mirror permits light from the first light source to pass through by rotating the first reflecting mirror away from a blocking position or using a semi-transparent material. The first reflecting mirror also redirects light coming from the second light source to the lens via the second reflecting mirror set. The lens focuses light from the first light source or the second light source and projects the light onto the optical sensor for the production of an image.

In the embodiment of this invention, the accumulation of dust and dirt on glass interface leading to the possible creation of Newton rings is also prevented. Since a light source carrier is no longer used, the need to synchronize light source carrier and carrier-sensor is avoided. Moreover, the deletion of the light source carrier reduces production cost. In addition, the introduction of a document feeding port on one side of the scanning device facilitates repetitive scanning.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic, cross-sectional side view of a conventional scanning system;

FIG. 2 is a sketch showing an integrated scanning device capable of conveniently operating in a reflection mode or a transparency mode according to a first preferred embodiment of this invention;

FIG. 3 is a sketch showing an integrated scanning device capable of conveniently operating in a reflection mode or a transparency mode according to a second preferred embodiment of this invention;

FIGS. 4A through 4D are sketches showing the sequences in operating the scanning device according to this invention, and

FIGS. 5A through 5C are sketches showing various types of reflecting mirrors used in the scanning device according to this invention.

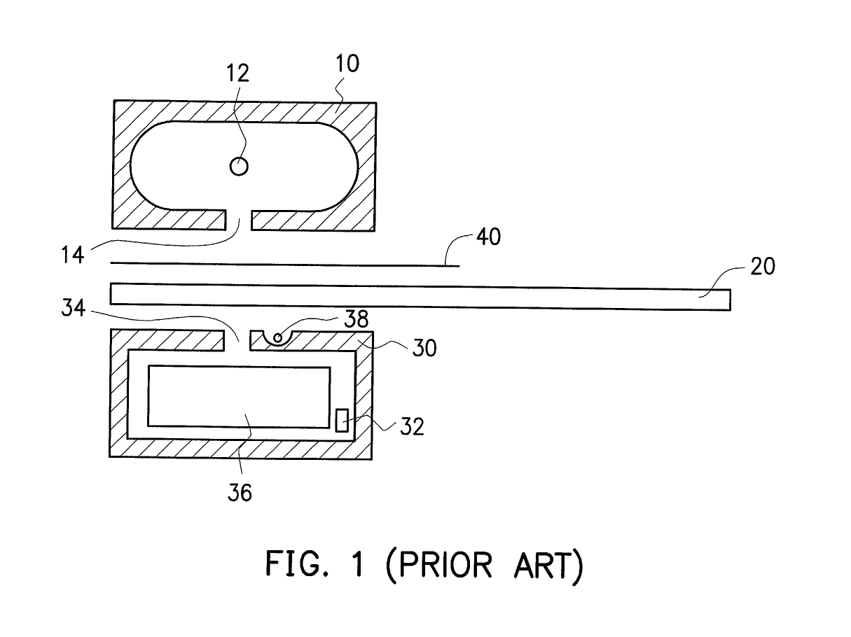

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

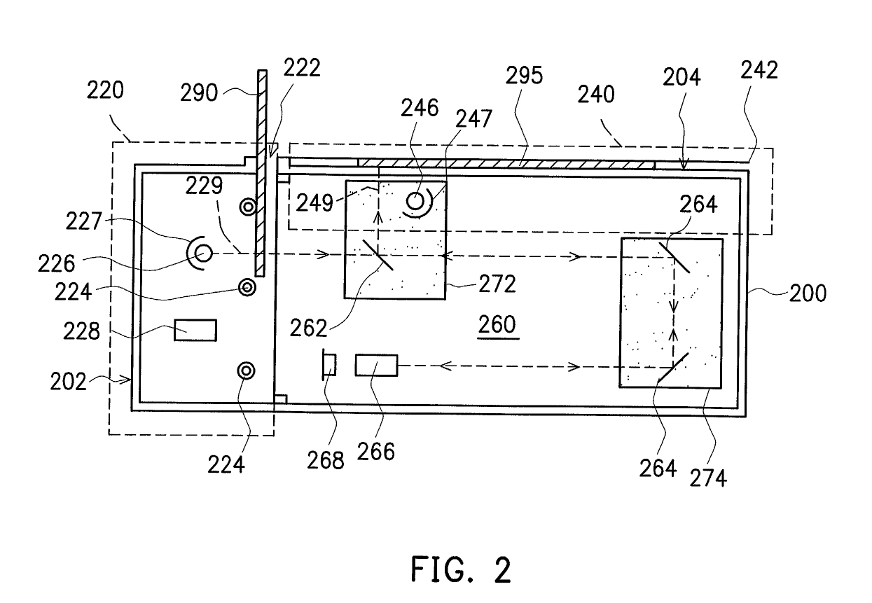

FIG. 2 is a sketch showing an integrated scanning device capable of conveniently operating in a reflection mode or a transparency mode according to a first preferred embodiment of this invention.

As shown in FIG. 2, a scanning device 200 having a side edge 202 and an upper surface 204 is provided. A transparency processing section 220 is located inside the scanning device 200 and close to the side edge 202. The transparency processing section 220 includes a document feeding port 222, a plurality of rollers 224, a first light source 226 and a driving motor 228. The document feeding port 222 has a long narrow slit in the upper surface 204 of the scanning device 200. The document feeding port 222 permits a vertical entrance of a scan document 290 into the scanning device 200. The rollers 224 are distributed along a vertical line from a position close to the document feeding port 222 towards the base of the scanning device 200. The first light source 226 is mounted somewhere between the document feeding port 222 and the side edge 202 of the scanning device 200. The first light source 226 includes a first light-focusing reflector 227. Light from the first light-focusing reflector 227 passes through the document 290 to produce a first light beam 229. The driving motor 228 is responsible for driving the rollers 224. The transparency processing section 220 further includes a repeat switch (not shown) for continuing or terminating transparency scanning.

The reflection processing section 240 is positioned close to the upper surface 204 of the scanning device 200. The reflection processing section 240 includes a second light source 246. The second light source 246 includes a second light-focusing mirror 247 for focusing light from the light source 246 and redirecting the light towards a document 295. After reflection from the document 295, a second light beam 249 is produced. The reflection processing section 240 further includes a cover panel 242. The cover panel 242 covers the upper surface 204 of the scanning device 200 and presses against the document 295. The scanning device 200 also includes a switch (not shown) for choosing between using the reflection processing section 220 to scan normal documents or using the transparency processing section 240 to scan transparent documents.

The optical system 260 is installed inside the scanning device 200. The optical system 260 includes a first reflecting mirror 262, a second reflecting mirror set 262, a lens 266 and an optical sensor 268. The first reflecting mirror 262 is positioned at the cross-point between the first light beam 229 and the second light beam 249. The first reflecting mirror 262 is either a semi-transparent, semi-reflective mirror or a rotary mirror. If the first reflecting mirror 262 is a semi-transparent, semi-reflective mirror, the first beam 229 is permitted to pass through while the second light beam 249 is reflected to the lens 266 via the second reflecting mirror set 264. On the other hand, if the first reflecting mirror 262 is a rotary mirror, the first beam 229 is permitted to pass through by rotating the reflecting mirror 262 away from the blocking position. The second light beam 249 is permitted to reflect into the lens 266 via the second reflecting mirror set 264 by rotating the reflecting mirror 262 back in position. The lens 266 focuses the first light beam 229 or the second light beam 249 and projects the light onto the optical sensor 268 to form an image. The optical sensor 268 can be a charge coupled device (CCD), for example.

The first reflecting mirror 262, the second light source 246 and the second light-focusing mirror 247 are fixed onto a first carrier 272. The second reflecting mirror set 264 is mounted on a second carrier 274. A scanning operation is conducted by moving the first carrier 272 and the second carrier 274 forward at a speed ratio of 1:2.

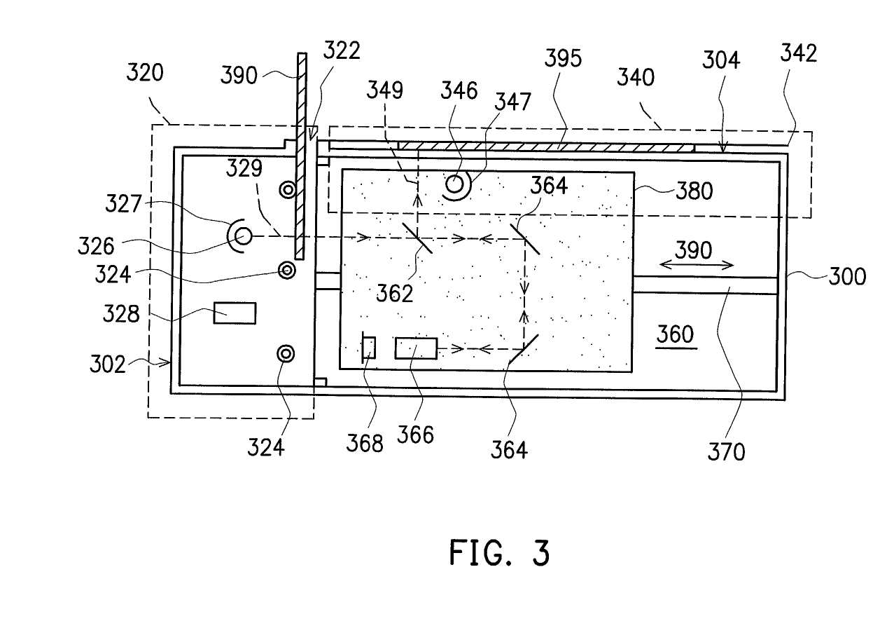

FIG. 3 is a sketch showing an integrated scanning device capable of conveniently operating in a reflection mode or a transparency mode according to a second preferred embodiment of this invention.

As shown in FIG. 3, a scanning device 300 having a side edge 302 and an upper surface 304 is provided. A transparency processing section 320 is located inside the scanning device 300 and close to the side edge 302. The transparency processing section 320 includes a document feeding port 322, a plurality of rollers 324, a first light source 326 and a driving motor 328. The document feeding port 322 has a long narrow slit in the upper surface 304 of the scanning device 300 for inserting a document vertically into the scanning device 300. The rollers 324 are distributed along a line starting from a region close to the document feeding port 322 towards the base of the scanning device 300. The first light source 326 is mounted between the document feeding port 322 and the side edge 302. The first light source 326 further includes a first light-focusing reflector 327 for collecting light from the first light source 326 and redirecting the light through the document 390 to produce a first light beam 329. The driving motor 328 is responsible for driving the rollers 324. The transparency processing section 320 further includes a repeat switch (not shown) for continuing or terminating transparency scanning.

The reflection processing section 340 is positioned close to the upper surface 304 of the scanning device 300. The reflection processing section 340 includes a second light source 346. The second light source 346 includes a second light-focusing mirror 347 for focusing light from the light source 346 and redirecting the light towards a document 395. After reflection from the document 395, a second light beam 349 is produced. The reflection processing section 340 further includes a cover panel 342. The cover panel 342 covers the upper surface 304 of the scanning device 300 and presses against the document 395. The scanning device 300 also includes a switch (not shown) for choosing between using the reflection processing section 320 to scan normal documents or using the transparency processing section 340 to scan transparent documents.

The optical system 360 is installed inside the scanning device 300. The optical system 360 includes a guide rail 370 and a carrier 380. The guide rail 380 is a linear rod whose ends are fastened to the scanning device 300. The carrier 380 is mounted onto the guide rail 370 so that the carrier 380 can slide towards both ends 390 of the guide rail 370. The carrier 380 has a fixed first reflecting mirror 368, a second reflecting mirror set 364, a lens 366, an optical sensor 368, a second light source 346 and a second light-focusing reflector 347. The second light source 346 is only triggered when the reflection processing section 340 is selected through the switch (not shown) of the scanning device 300. The first reflecting mirror 362 is positioned at the cross-point between the first light beam 329 and the second light beam 349. The first reflecting mirror 362 is either a semi-transparent, semi-reflective mirror or a rotary mirror. If the first reflecting mirror 362 is a semi-transparent, semi-reflective mirror, the first beam 329 is permitted to pass through while the second light beam 349 is reflected to the lens 366 via the second reflecting mirror set 364. On the other hand, if the first reflecting mirror 362 is a rotary mirror, the first beam 329 is permitted to pass through by rotating the reflecting mirror 362 away from the blocking position. The second light beam 349 is permitted to reflect into the lens 366 via the second reflecting mirror set 364 by rotating the reflecting mirror 362 back in position. The lens 366 focuses the first light beam 329 or the second light beam 349 and projects the light onto the optical sensor 368 to form an image. The optical sensor 368 can be a charge coupled device (CCD) or a contact image sensor (CIS), for example.

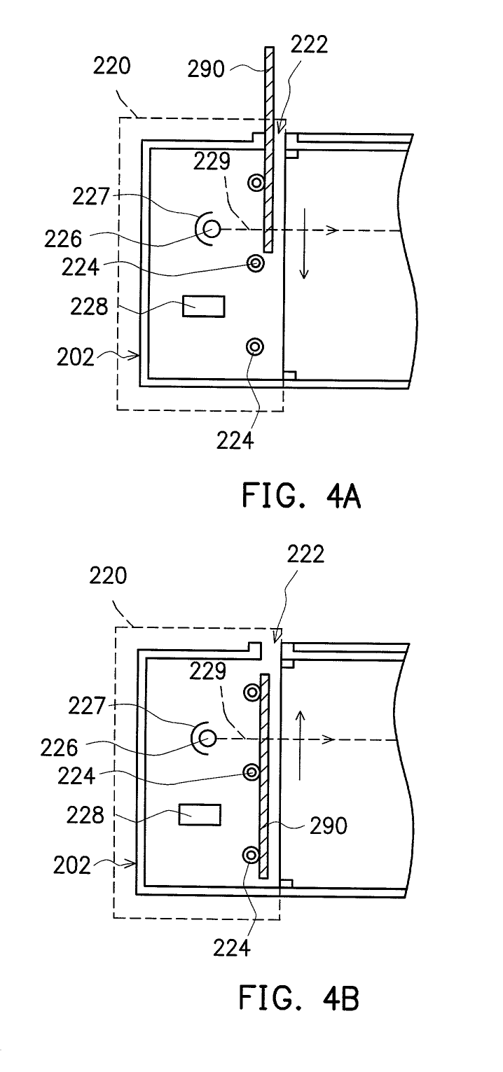

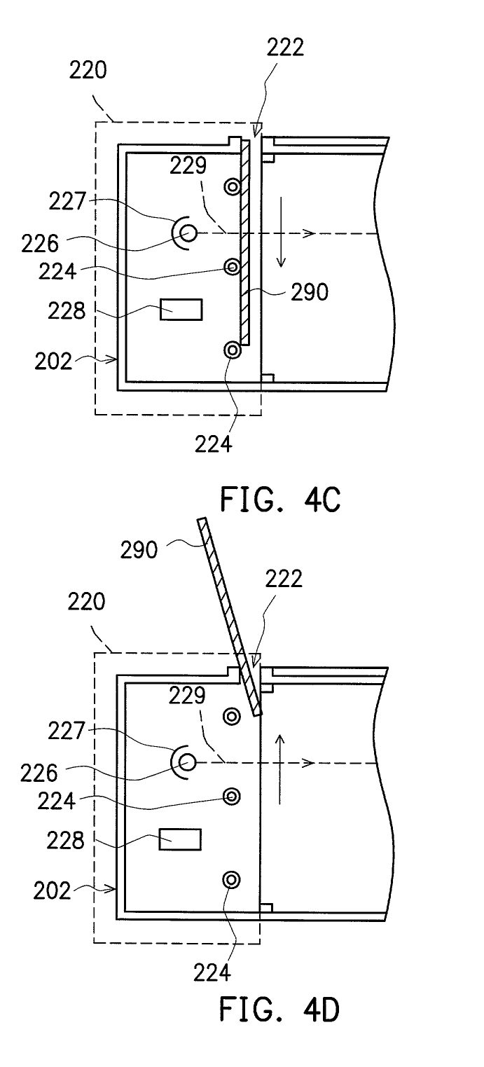

FIGS. 4A through 4D are sketches showing the sequences in operating the scanning device according to this invention.

As shown in FIG. 4A, when the selection switch (not shown) of the scanning device 200 points to operate in the transparency processing mode, the document 290 is positioned vertically at the document feeding port 222 to begin scanning.

As shown in FIG. 4B, the first light source 226 is turned on. Light from the first light source 226 is redirected by the first light-focusing mirror 227 through the transparent document 290 to form a first light beam 229. Meanwhile, the driving motor 228 starts to move rotating the rollers 224 such that the document 290 is gradually fed into the scanning device 200.

If the repeat switch (not shown) for operating the transparency processing section 220 is on, the driving motor 228 will reverse and forward again for a period as shown in FIG. 4C. In other words, the rollers 224 together move the document 290 backward and forward for another round of scanning.

However, if the repeat switch (not shown) for operating the transparency processing section 220 is off, the driving motor 228 will simply reverse the direction. In other words, the rollers 224 rotate in synchrony to eject the document 290 from the scanning device 200 as shown in FIG. 4D.

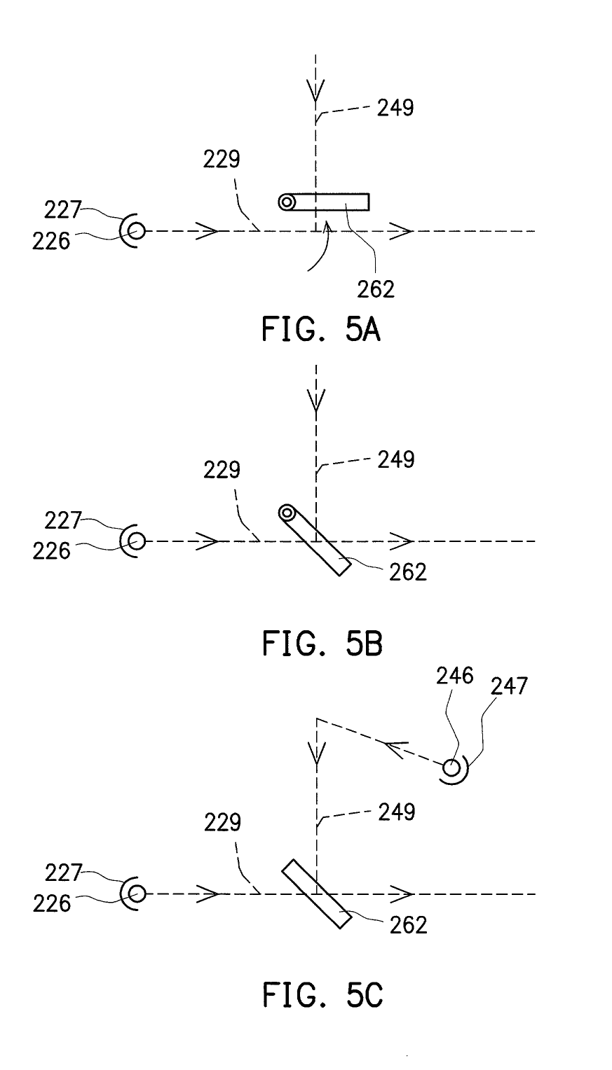

FIGS. 5A through 5C are sketches showing various types of reflecting mirrors used in the scanning device according to this invention.

As shown in FIG. 5A, when the switch (not shown) in the scanning device 200 is flipped to a position for operating the transparency processing section 220, the first light source 226 is triggered. The reflecting mirror 262 rotates to a horizontal level so that the first light beam 229 is able to pass unimpeded.

As shown in FIG. 5B, when the switch (not shown) in the scanning device 200 is flipped to a position for operating the reflection processing section 240, the second light source 246 is triggered. The first reflecting mirror 262 rotates an angle of 45_so that light from the second light beam 249 is reflected by the first reflecting mirror 262.

The first reflecting mirror 262 can be a mirror formed using a semi-transparent, semi-reflecting material. If the first reflecting mirror 262 has a semi-transparent, semireflecting design as shown in FIG. 5C, there is no need to rotate the mirror 262 to a horizontal position when the transparency processing section 220 is selected. Similarly, there is no need to rotate 45_when the reflection processing section 240 is selected. In other words, the first light beam 229 is permitted to penetrate the reflecting mirror 262 while the second light beam 249 is reflected by the reflecting mirror 262 without any mirror movement.

In summary, major advantages of this invention include the following:

1. A light source carrier is unnecessary. Hence, the formation of Newton rings due to dust and dirt on the glass interface can be prevented.

2. Image discrepancies due to a relative movement between a light source carrier and a sense-carrier are avoided.

3. Without the need to fabricate a light source carrier, production cost is reduced.

4. The introduction of a side document feeding port for scanning transparent document facilitates repeated scanning.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An integrated reflection and transparency scanning device having a side edge and an upper surface, comprising:
a transparency processing section located inside the scanner close to the side edge, wherein the transparency processing section includes a document feeding port, a plurality of rollers, a first light source and a driving motor, wherein the document feeding port has a long narrow slit in the upper surface of the scanning system, the rollers are evenly distributed from a region close to the document feeding port towards a base of the scanning device, the first light source is positioned between the document feeding port and the side edge for producing a first light beam, and the driving motor is used for driving the rollers in a vertical direction;
a reflection processing section close to the upper surface of the scanning device, wherein the reflection processing section includes a second light source located inside the scanning device close to the upper surface for producing a second light beam; and
an optical system inside the scanning device, wherein the optical system includes a first carrier, a second carrier, a lens and an optical sensor, wherein the first carrier includes a first reflection mirror, the second carrier includes a second reflection mirror set, the first reflection mirror is located at a cross-point between the first light beam and the second light beam, the second reflection mirror set deflects the first light beam or the second light beam towards the lens, and the lens focuses the first light beam or the second light beam and projects the light beam onto the optical sensor for the production of an image.

2. The scanning device of claim 1, wherein the first carrier and the second carrier move together synchronously with a speed ratio of 1:2.

3. The scanning device of claim 1, wherein the second light source of the reflection processing section is installed within the first carrier.

4. The scanning device of claim 1, wherein the first light source further includes a first light-focusing reflector for focusing light from the first light source into the first light beam.

5. The scanning device of claim 1, wherein the second light source further includes a second light-focusing reflector for focusing light from the second light source into the second light beam.

6. The scanning device of claim 1, wherein the first reflecting mirror in the optical system has semi-transparent, semi-reflecting properties.

7. The scanning device of claim 1, wherein the first reflecting mirror in the optical system has a hinge for rotation.

8. The scanning device of claim 1, wherein the scanning device further includes a switch for selection between the reflection processing section and the transparency processing section.

9. The scanning device of claim 1, wherein the transparency processing section further includes a repeat switch for continuing or terminating a transparency processing operation.

10. The scanning device of claim 1, wherein the optical sensor in the optical system includes a charge coupled device.

11. The scanning device of claim 1, wherein the reflection processing section further includes a cover panel for laying over the upper surface of the scanning device.

12. An integrated reflection and transparency scanning device having a side edge and an upper surface, comprising:
a transparency processing section located inside the scanner and close to the side edge, wherein the transparency processing section includes a document feeding port, a plurality of rollers, a first light source and a driving motor, wherein the document feeding port has a long narrow slit in the upper surface of the scanning system, the rollers are evenly distributed from a region close to the document feeding port towards a base of the scanning device, the first light source is positioned between the document feeding port and the side edge for producing a first light beam, and the driving motor is used for driving the rollers in a vertical direction;
a reflection processing section close to the upper surface of the scanning device, wherein the reflection processing section includes a second light source located inside the scanning device and close to the upper surface for producing a second light beam; and
an optical system inside the scanning device, wherein the optical system includes a guide rail and a carrier, wherein the guide rail is a linear rod whose ends are fastened to the scanning device, and the carrier is mounted on the guide rail so the carrier can move towards either end of the guide rail.

13. The scanning device of claim 12, wherein the carrier of the optical system further includes a first reflecting mirror, a second reflecting mirror set, a lens and an optical sensor, wherein the first reflecting mirror is located at the cross-point between the first light beam and the second light beam, the second reflection mirror set deflects the first light beam or the second light beam towards the lens, and the lens focuses the first light beam or the second light beam and projects the light beam onto the optical sensor for the production of an image.

14. The scanning device of claim 13, wherein the first reflecting mirror in the optical system has semi-transparent, semi-reflecting properties.

15. The scanning device of claim 13, wherein the first reflecting mirror in the optical system has a hinge for rotation.

16. The scanning device of claim 13, wherein the optical sensor in the optical system includes a charge coupled device.

17. The scanning device of claim 13, wherein the optical sensor in the optical system includes a contact image sensor.

18. The scanning device of claim 12, wherein the first light source further includes a first light-focusing reflector for focusing light from the first light source into the first light beam.

19. The scanning device of claim 12, wherein the second light source further includes a second light-focusing reflector for focusing light from the second light source into the second light beam.

20. The scanning device of claim 12, wherein the scanning device further includes a switch for selecting between the reflection processing section and the transparency processing section.

21. The scanning device of claim 12, wherein the transparency processing section further includes a repeat switch for continuing or terminating a transparency processing operation.

22. The scanning device of claim 12, wherein the reflection processing section further includes a cover panel that lies over the upper surface of the scanning device.
